(19) United States
(12) Patent Application Publication
(10) Pub. No.: US 2024/0174769 A1
(43) Pub. Date: May 30, 2024

(54) DISSOLUTION METHOD

(71) Applicant: FUTAMURA CHEMICAL UK LTD, Wigton (GB)

(72) Inventors: Martin Richard COCKROFT, Wigton (GB); Luke FISHER, Wigton (GB)

(21) Appl. No.: 18/551,529

(22) PCT Filed: Mar. 17, 2022
(86) PCT No.: PCT/EP2022/056934

§ 371 Date: Sep. 20, 2023

(30) Foreign Application Priority Data
Mar. 26, 2021 (GB) 2104273.4

(51) Int. Cl. C08B 1/00; C08B 9/00; C08B 16/00; C08J 5/18; C08L 1/24

(52) U.S. Cl. CPC C08B 1/003; C08B 9/00; C08B 16/00; C08J 5/18; C08L 1/24; C08J 2301/02; C08J 2301/24

(57) ABSTRACT

The present invention provides a method for creating a solution comprising one or more polysaccharide materials dissolved in an alkali, including the step of subjecting a mixture comprising the one or more polysaccharide materials and the alkali to high-pressure homogenisation.

This application is a National Stage application claims priority from the international application PCT/EP2022/056934, filed Mar. 17, 2022, which claims priority from the United Kingdom application No. 2104273.4 filed Mar. 26, 2021. The entirety of the aforementioned applications is incorporated herein by reference.

### FIELD

The present invention provides a method for creating a solution comprising one or more polysaccharide materials, particularly cellulose, dissolved in an alkali.

### BACKGROUND

It is well-known to dissolve polysaccharides, such as cellulose, in an alkali to allow further processing of the polysaccharide. In the case of cellulose, this further processing may involve the creation of regenerated cellulose products in the form of a film, a fibre or a shaped article. Dissolving polysaccharides in an alkali is particularly attractive because it is simple and uses reagents which are recyclable, cheap, and widely available. However, in order to dissolve a polysaccharide directly in an alkali such as sodium hydroxide, extremely cold temperatures are required.

Budtova et al., “Cellulose in NaOH-water based solvents: a review”, Cellulose, Springer Verlag, 2016, 23 (1), p5-55 is a review article which discusses the dissolution of cellulose in NaOH-based aqueous solutions, wherein it is made clear that low temperatures are considered essential for the mixing and dissolution of cellulose in sodium hydroxide. However, as discussed in this document, stability of the solutions is problematic, with many solutions gelling quickly after formation.

WO2007060296 describes a method for preparing a cellulose carbamate solution, in which the dissolution of cellulose carbamate in alkaline aqueous solution is performed in two steps with solutions of different concentrations. The cellulose carbamate is first admixed into a cooled dilute NaOH solution whose alkali concentration is 4% at the most, preferably at a temperature of below 5° C. In the second step, the rest of the alkali is dosed in a concentration of about 15 to 22% and at a temperature of below −15° C., under intensive stirring. Therefore, this document demonstrates the requirement for the solution to be kept at a low temperature throughout the dissolution process.

WO2017178531 describes a method for the production of a spinning dope composition, comprising a homogenization involving vigorous mixing of a cellulosic pulp material in alkali solution, vigorous mixing implying supplying a power density of at least 150 kW/m³ to agitators used in the homogenization step, and thereafter a dissolution involving mixing of the cellulosic pulp material in the alkali solution to obtain a spinning dope composition. The power density supplied to agitators used in the dissolution step is maximum 75 kW/m³. The cellulosic pulp material in alkali solution is kept at a temperature of less than 0° C. during the homogenization and during at least part of the dissolution.

Thus, there remains a need in the art for methods of creating a solution of a polysaccharide material which can be performed at higher temperatures than those previously used in the art and therefore do not require the equipment and energy needed to maintain the conventional low temperatures. There also remains a need in the art for solutions of a polysaccharide material with improved gel stability. Further, there remains a need in the art for polysaccharide products with improved mechanical properties.

It is known in the art to use homogenisation to create dispersions or suspensions, for example CN104312809 describes the high-pressure homogenisation of treated microcrystalline cellulose in water to produce a homogenised microcrystalline suspension.

CN108359019 describes the high-pressure homogenisation of a turmeric feed solution, at a pressure between 50-55 kPa, to produce a homogenous solid and a homogeneous liquid.

CN107400177 describes the homogenisation of sunflower seed meal dissolved in 2% sodium sulphite to extract hydrolysed protein.

US2020248405 describes the homogenisation of a dispersion of comminuted cellulosic material through high shear or high pressure to form a nanocellulose dispersion.

The above prior art describes conditions where homogenisation of materials, for example cellulosic materials, creates dispersions or suspensions. Therefore, there remains a need to create suitable conditions under which cellulosic material can be dissolved.

### BRIEF DESCRIPTION OF THE DRAWINGS

FIG. 1 illustrates a solution containing NaOH and cellulose from tomato leaves, both before (1A) and after (1B) high-pressure homogenisation.

FIG. 2 illustrates a solution containing NaOH and cellulose from straw, both before (2A) and after (2B) high-pressure homogenisation.

FIG. 3 illustrates a solution containing NaOH and cellulose from rice husks, both before (3A) and after (3B) high-pressure homogenisation.

FIG. 4 illustrates a solution containing NaOH and cellulose from straw, both before (4A) and after (4B) high-pressure homogenisation.

FIG. 5 illustrates a solution containing NaOH and cellulose from straw, both before (5A) and after (5B) high-pressure homogenisation.

FIG. 6 illustrates a solution containing NaOH and cellulose from hemp, both before (6A) and after (6B) high-pressure homogenisation.

FIG. 7 illustrates a solution containing NaOH and cellulose from oat hulls, both before (7A) and after (7B) high-pressure homogenisation.

FIG. 8 illustrates a solution containing NaOH and cellulose from hemp, both before (8A) and after (8B) high-pressure homogenisation.

FIG. 9 illustrates a solution containing NaOH and cellulose from tomato leaves, both before (9A) and after (9B) high-pressure homogenisation.

FIG. 10 illustrates a solution containing NaOH and cellulose from hemp, which has undergone a pre-treatment, both before (10A) and after (10B) high-pressure homogenisation.

FIG. 11 illustrates a solution containing NaOH and cellulose from hemp, which has undergone a pre-treatment, both before (11A) and after (11B) high-pressure homogenisation.

FIG. 12 illustrates a solution containing NaOH and plant alkali cellulose, which has undergone a pre-treatment, both before (12A) and after (12B) high-pressure homogenisation.

FIG. 13 illustrates a solution containing NaOH and plant alkali cellulose, which has undergone a pre-treatment, both before (13A) and after (13B) high-pressure homogenisation.

FIG. 14 illustrates a solution containing NaOH and cellulose prior to homogenisation (14A), after one pass through the high-pressure homogeniser (14B), and after two passes through the high-pressure homogeniser (14C), wherein the solution was held for 30 minutes prior to high-pressure homogenisation.

FIG. 15 illustrates a solution containing NaOH and cellulose prior to homogenisation (15A), after one pass through the high-pressure homogeniser (15B), and after two passes through the high-pressure homogeniser (15C), wherein the solution was held for 2 hours prior to high-pressure homogenisation.

FIG. 16 illustrates a solution containing NaOH and cellulose prior to homogenisation (16A), after one pass through the high-pressure homogeniser (16B), and after two passes through the high-pressure homogeniser (16C), wherein the solution was held for 12 hours prior to high-pressure homogenisation.

FIG. 17 illustrates a solution containing NaOH and cellulose prior to homogenisation (17A), after one pass through the high-pressure homogeniser (17B), and after two passes through the high-pressure homogeniser (17C), wherein the solution was held for 72 hours prior to high-pressure homogenisation.

FIG. 18 illustrates a solution containing NaOH at −20° C. and cellulose prior to homogenisation (18A), after one pass through the high-pressure homogeniser (18B), and after two passes through the high-pressure homogeniser (18C), wherein the solution was mixed at 2° C. for 20 minutes prior to high-pressure homogenisation.

FIG. 19 illustrates a solution containing NaOH at −20° C. and cellulose prior to homogenisation (19A), after one pass through the high-pressure homogeniser (19B), and after two passes through the high-pressure homogeniser (19C), wherein the solution was mixed at 2° C. for 24 hours prior to high-pressure homogenisation.

FIG. 20 illustrates a solution containing ambient temperature NaOH and cellulose prior to homogenisation (20A), after one pass through the high-pressure homogeniser (20B), and after two passes through the high-pressure homogeniser (20C), wherein the solution was mixed at 2° C. for 20 minutes prior to high-pressure homogenisation.

FIG. 21 illustrates a solution containing ambient temperature NaOH and cellulose prior to homogenisation (21A), after one pass through the high-pressure homogeniser (21B), and after two passes through the high-pressure homogeniser (21C), wherein the solution was mixed at 2° C. for 24 hours prior to high-pressure homogenisation.

FIG. 22 illustrates a solution containing ambient temperature NaOH and cellulose prior to homogenisation (22A), after one pass through the high-pressure homogeniser (22B), and after two passes through the high-pressure homogeniser (22C), wherein the solution was mixed at ambient temperature for 20 minutes prior to high-pressure homogenisation; and

FIG. 23 illustrates a solution containing ambient temperature NaOH and cellulose prior to homogenisation (23A), after one pass through the high-pressure homogeniser (23B), and after two passes through the high-pressure homogeniser (23C), wherein the solution was mixed at ambient temperature for 24 hours prior to high-pressure homogenisation.

### DETAILED DESCRIPTION

According to a first aspect of the present invention, there is provided a method for creating a solution comprising one or more polysaccharide materials dissolved in an alkali, including the step of subjecting a mixture comprising the one or more polysaccharide materials and the alkali to high-pressure homogenisation.

The term “high-pressure homogenisation” herein refers to homogenisation at a pressure of more than 100 bar.

The term “polysaccharide material” herein refers to a material containing a polysaccharide. The majority of the material may be a polysaccharide. The polysaccharide material may be entirely polysaccharide.

The solution may comprise one polysaccharide material. The solution may comprise a plurality of polysaccharide materials. The solution will be known as the Rahcel solution.

The alkali may be an aqueous alkali, preferably an aqueous alkali hydroxide such as an aqueous alkali metal hydroxide. The aqueous alkali hydroxide may be sodium hydroxide.

The alkali may have a concentration between 5% w/w and 25% w/w, or between 10% w/w and 25% w/w.

The inventors of the present invention have surprisingly found that subjecting a mixture comprising the one or more polysaccharide materials and the alkali to high-pressure homogenisation causes the one or more polysaccharide materials to dissolve. The polysaccharide dissolution can occur at elevated temperatures, as compared to those temperatures previously used in the art. At least part of the method described herein can therefore occur at ambient temperature (20° C.) or above.

Furthermore, high-pressure homogenisers increase the temperature of the mixture due to fixed friction and shear effects. Therefore, there is a prejudice in the art against the use of a high-pressure homogeniser for polysaccharide dissolution, because of the conventional understanding that the mixture comprising the one or more polysaccharide materials and the alkali must be kept at a low temperature during the dissolution method. The inventors have surprisingly found that this temperature increase resulting from the high-pressure homogenisation is not detrimental to the polysaccharide dissolution and instead, the high-pressure homogenisation improves the degree of polysaccharide dissolution in the alkali, even at temperatures above those used in the art.

The inventors have also surprisingly found that the polysaccharide solutions of the present invention have superior stability compared to polysaccharide solutions in the art, particularly with respect to gelation and optical clarity. Specifically, the resulting solution comprising one or more polysaccharide materials dissolved in an alkali can be stored at higher temperatures than those used in the art, and for longer, without gelling occurring.

In addition, the inventors have surprisingly found that the polysaccharide solutions of the present invention are compatible with other polysaccharide solutions, such as viscose. This advantageously enables a plant such as a viscose plant to part-convert its process to allow for a greener product, particularly when the polysaccharide material of the present method is derived from agricultural waste or the like, without significant investment and/or modifications to the plant.

The temperature of the mixture during at least part of the high-pressure homogenisation may be greater than 0° C., preferably greater than 5° C. All of the dissolution process can occur at a temperature of above 0° C. The inventors have surprisingly found that at least part of the high-pressure homogenisation can occur at temperatures above 0° C., preferably between 2 and 30° C., which are much higher than the cold dissolution temperatures used in the art.

Preferably, the temperature of the mixture during the high-pressure homogenisation does not exceed 35° C. If the temperature of the mixture during the high-pressure homogenisation reaches above 35° C., it will form a reversible thick gelatinous material. Without wishing to be bound by theory, it is thought that the elevated temperature causes precipitation of the polysaccharide material due to some form of coagulation process, possibly via temporary dehydration. This demonstrates that the polysaccharide material is indeed dissolved rather than suspended.

The mixture comprising the one or more polysaccharide materials and the alkali may be formed at a low temperature. The one or more polysaccharide materials and the alkali may be combined at temperatures of between −25° C. and 15° C., preferably between −10° C. and 10° C. Conducting at least the initial stages of the dissolution method at a low temperature can improve the solubility of the one or more polysaccharide materials, thereby ensuring that the one or more polysaccharide materials dissolve during the high-pressure homogenisation rather than creating a dispersion. Thus, the temperature of the mixture immediately before high-pressure homogenisation is preferably between −20° C. and 15° C., more preferably between −5° C. and 10° C. and more preferably between 0° C. and 10° C.

The one or more polysaccharide materials may be mixed with water before being mixed with an alkali to create the mixture comprising the one or more polysaccharide materials and the alkali. The one or more polysaccharide materials may be mixed with water at a temperature of between −5° C. and 10° C., preferably between 0° C. and 5° C. Alternatively, the one or more polysaccharide materials may be initially mixed with water at a higher temperature, for example ambient temperature, before reducing the temperature of the mixture to between −5° C. and 10° C., preferably between 0° C. and 5° C.

The alkali may be cooled to a temperature of between −25° C. and −10° C., preferably between −20° C. and −15° C., and then added to the one or more polysaccharide materials, preferably to the mixture comprising the one or more polysaccharide materials and water, to create the mixture comprising the one or more polysaccharide materials and the alkali. Alternatively, the alkali may be cooled to a temperature of between −5° C. and 10° C., preferably between 0° C. and 5° C. before it is added to the one or more polysaccharide materials.

The alkali may be added as an aqueous solution, preferably having a concentration between 5% w/w and 25% w/w. The lower end of this range, for example between 5 and 15 w/w %, may be used when the polysaccharide is alkaline.

The mixture comprising the one or more polysaccharide materials and the alkali may be treated to increase the homogeneity of the mixture before the high-pressure homogenisation. During this treatment, the temperature of the mixture may be between −5° C. and 15° C., or between 0° C. and 10° C.

This treatment to increase homogeneity may involve mixing or agitating the mixture comprising the one or more polysaccharide materials and the alkali, optionally using a high shear mixer, such as SILVERSON™-style heads. Alternatively, the mixture comprising the one or more polysaccharide materials and the alkali may be treated using a low shear mixer, such as low shear agitation. The mixing or agitation of the mixture may be for a period of time between 1 hour and 24 hours, preferably between 3 and 20 hours, more preferably between 5 and 15 hours. The mixing or agitation of the mixture may be left overnight.

This treatment ensures that there are no polysaccharide aggregates present in the mixture, which would decrease the effectiveness of the high-pressure homogenisation treatment. This initial treatment may cause some of the one or more polysaccharide materials to dissolve in the alkali solution. However, a significant portion will remain undissolved and in a fibrous state suspended in the alkali.

The method may include a saturation step prior to high-pressure homogenisation, in which the mixture comprising the one or more polysaccharide materials and the alkali is held below ambient temperature. Preferably, the saturation step occurs at above 0° C. The mixture comprising the one or more polysaccharide materials and the alkali may be held prior to high-pressure homogenisation at a temperature of between −5° C. and 15° C., preferably between 0° C. and 10° C. The saturation step may occur for 0.3 hours to 120 hours, more preferably for 24 hours to 72 hours.

The mixture may be agitated or mixed during the saturation step. The mixing or agitation may be achieved using conventional means. The mixing may be done at 400 to 1000 RPM.

The inventors have surprisingly found that such a saturation step can increase the quality of the final solution, with an increase in the length of the saturation step increasing the quality of the final solution. Without wishing to be bound by theory, it is thought that this step softens the polysaccharide material to make high-pressure homogenisation more effective. Additionally, the polysaccharide material may start to dissolve during this saturation step. Preferably, this saturation step takes place after the aforementioned treatment to increase the homogeneity of the mixture.

The saturation step may mean that the alkali does not need to be cooled to the low temperatures of between −25° C. and −10° C. before it is added to the one or more polysaccharide materials, as discussed above. Instead, the alkali could be added at ambient temperatures and subsequently cooled to between −5° C. and 15° C., or between 0° C. and 10° C. Alternatively, the alkali could be added to the one or more polysaccharide materials at temperatures between −5° C. and 15° C., or between 0° C. and 10° C. The longer the saturation step, the warmer the alkali can be when it is added to the one or more polysaccharide materials. This significantly improves the energy usage and the ease of the dissolution process, as the very low temperatures of conventional processes are not required. Thus, the dissolution process can be conducted at above 0° C.

The mixture comprising the one or more polysaccharide materials and the alkali may undergo a plurality of high-pressure homogenisation steps. Multiple passes through the high-pressure homogeniser may be required to achieve substantially complete dissolution (i.e. more than 95% dissolution). One, two, three, four, five or six passes through the high-pressure homogeniser may be required to achieve substantially complete dissolution.

The mixture may be cooled to between −5° C. and 15° C., preferably to between 0° C. and 10° C., between at least two of the high-pressure homogenisation steps, preferably between each high-pressure homogenisation step. The mixture comprising the one or more polysaccharide materials and the alkali may be cooled to between −5° C. and 15° C., preferably to between 0° C. and 10° C., directly after all of the one or more high-pressure homogenisation steps. This improves the degree of dissolution following high-pressure homogenisation and/or the degree of dissolution in the final solution, at the end of the homogenisation process.

The mixture may be held at the cooled temperature of between −5° C. and 15° C., preferably between 0° C. and 10° C., for a period of time sufficient to increase dissolution of the one or more polysaccharide materials after one or more of the high-pressure homogenisation steps. This period of time may be between 5 minutes and three hours, preferably between 10 minutes and two hours. The mixture may be agitated at this cooled temperature, preferably a low level, slow agitation. This step of agitation at a low temperature is also referred to as recirculation.

It has been found that recirculation improves the dissolution of the one or more polysaccharide materials. A large viscosity drop was observed during recirculation steps after a high-pressure homogenisation step, demonstrating that the homogenised fibres were dissolving. The recirculation step also allows the mixture to cool before any further high-pressure homogenisation steps, thereby preventing the temperature of the mixture from going above 35° C.

Some or all of the one or more polysaccharide materials may be pre-treated to remove impurities. This improves the reactivity and the solubility of the one or more polysaccharide materials in the alkali.

The one or more polysaccharide materials may be pre-treated by drying, shredding, cutting, macerating and/or washing. The pre-treatment may additionally or alternatively comprise the addition of enzymes and/or the use of ion exchange resins.

The one or more polysaccharide materials may be pre-treated with a pre-treatment alkali solution. This has been found to further improve the solubility of the one or more polysaccharide materials, particularly in the case of cellulose materials, and to help create a solution that is stable and does not irreversibly gel. The pre-treatment may comprise steeping one or more of the polysaccharide materials in the pre-treatment alkali solution.

The steeping process may involve creating a steeping mixture comprising a mixture of the one or more polysaccharide materials and the pre-treatment alkali solution. The steeping mixture may comprise 1 to 10% polysaccharide, preferably cellulose. The steeping mixture may comprise 10 to 25% alkali, preferably 15 to 20% alkali.

The steeping process may be conducted at elevated temperatures, such as between 40 and 60° C. At elevated temperatures, the steeping process may be conducted for between 5 minutes and two hours, preferably between 5 and 60 minutes.

The steeping process may also be conducted at lower temperatures, such as between 5 and 50° C. At these temperatures, the steeping process may be conducted for between 5 minutes and 36 hours, preferably between 1 and 24 hours.

The steeping mixture may comprise one or more additives to help reduce the molecular weight of the one or more polysaccharide materials (such as manganese sulphate) or increase reactivity (such as Berol 388, urea or zinc).

The one or more polysaccharide materials may then be separated from the pre-treatment alkali. This may be done by filtration, pressing, or other methods known in the art.

The resulting polysaccharide material solid may then be left to mercerise via oxidative degradation for up to a period of 72 hours, in order to achieve the correct molecular weight. This can be done at a temperature of between 20 and 60° C., preferably 30 to 50° C.

The polysaccharide material solid may be used directly to create a mixture comprising the one or more polysaccharide materials and an alkali in accordance with the method of the invention, or may be neutralised with an acid as part of the pre-treatment. Alternatively or additionally, the one or more polysaccharide materials may be treated with a bleach before being mixed with an alkali. These pre-treatment steps may be in accordance with the steps disclosed in WO2021001557, which is incorporated herein by reference. The one or more polysaccharide materials may be dried before being used in the method of the present invention.

The acid may comprise a weak acid, which may be a carboxylic acid, such as acetic acid. The concentration of acid may be about 1 to about 20% w/w.

The bleach may be neat. The term “neat” is to be construed to mean that the bleach contains no other components, for example the bleach has not been diluted and is without solvent.

The bleach may comprise a chlorine containing bleach. For example, the bleach may comprise sodium hypochlorite. Alternatively, the bleach may comprise non-chlorine containing bleach. For example, the bleach may comprise hydrogen peroxide.

The bleach may be at a concentration of between 0.1 and 10% w/w, preferably between 0.1 and 2% w/w.

The alkali and/or the pre-treatment alkali solution may be an aqueous alkali, preferably an aqueous alkali hydroxide. The alkali and/or the pre-treatment alkali solution may be sodium hydroxide. The alkali and the pre-treatment alkali may be the same or different. Both the alkali and the pre-treatment alkali may be aqueous sodium hydroxide.

The one or more polysaccharide materials may include a cellulose material, i.e. a material containing cellulose. The majority of the one or more polysaccharide materials may be a cellulose material. The cellulose material may consist of cellulose. The one or more polysaccharide materials may include a material that contains derivatives of cellulose, such as hydroxypropyl cellulose or carboxymethylcellulose. The one or more polysaccharide materials may include a material that contains a polysaccharide found in plant material, such as hemicellulose (e.g. xylan or xyloglucan), callose, beta glucan and/or glucomannan. The one or more polysaccharide materials may include a material that contains starch, polylactic acid, chitin and/or chitosan material.

The solution may comprise or consist of a cellulose material as the polysaccharide material. The solution may comprise a cellulose material as one polysaccharide material, in addition to one or more further polysaccharide materials. The cellulose material may be present in equal or greater amounts than the one or more further polysaccharide materials.

The cellulose material may be any material containing cellulose, including agricultural waste or wood pulp. The agricultural waste may be selected from oat hulls, tomato leaves, rice husks, jute, straw, wheat, miscanthus, hemp, grass, flax or food crop waste. Other suitable agricultural waste sources may include coconut fibre, tea shell, chaff fibres, Phoenix dactylifera, Borassus flabellifer, leaf stalks or ginger. The cellulose material may be fresh, rather than aged (for example, picked less than three weeks ago), as aging the material can create contaminants.

The mixture comprising the one or more polysaccharide materials and the alkali may comprise between 1 and 10% w/w polysaccharide, preferably between 2 and 8% w/w polysaccharide. Preferably the polysaccharide comprises cellulose. The mixture comprising the one or more polysaccharide materials and the alkali may comprise between 1 and 15% w/w alkali, preferably between 3 and 11% w/w alkali, more preferably between 7 and 10% w/w alkali. The amount of one or more polysaccharide materials present in the mixture may be dependent on the nature of the feedstock from which the one or more polysaccharide materials are derived. The rest of the mixture may comprise or consist of water and impurities from the one or more polysaccharide materials.

When the polysaccharide material comprises a cellulose material, the degree of polymerisation in the cellulose material before high-pressure homogenisation may be less than 500, preferably between 100 and 300. The inventors have found that this degree of polymerisation aids in the provision of a stable cellulose solution, while ensuring a strong final product.

The specific conditions for high-pressure homogenisation depend on the nature of the feedstock from which the one or more polysaccharide materials are derived. The high-pressure homogenisation may occur at a pressure of between 100 and 1000 bar, preferably 150 to 750 bar. The total combined pressure of the high-pressure homogenisation steps may not exceed 1000 bar. The inventors of the present invention have surprisingly found that this range is particularly effective at dissolving polysaccharides derived from a wide range of feedstocks.

A second high-pressure homogenisation step, when present, may use a pressure lower than the pressure in the first high-pressure homogenisation step. This has been found to provide good dissolution of one or more polysaccharide materials in the alkali. Preferably the pressure in the second high-pressure homogenisation step is between 15 and 30% of the pressure in a first high-pressure homogenisation step. Any subsequent high-pressure homogenisation step may also use a pressure lower than the pressure in the first high-pressure homogenisation step, preferably between 15 and 30% of the pressure in a first high-pressure homogenisation step.

More than 95% and preferably more than 98% of the one or more polysaccharide materials in the mixture may dissolve in the alkali following high-pressure homogenisation. Thus, substantially complete dissolution is achieved using the method of the present invention.

The solution may be filtered following high-pressure homogenisation, to remove any residual undissolved polysaccharide material or contamination fragments.

According to a second aspect, there is provided a solution comprising one or more polysaccharide materials dissolved in an alkali, wherein the solution does not undergo irreversible gelation at 20° C. for at least two weeks. Preferably, the solution does not undergo irreversible gelation at 20° C. for at least a month.

The solution described herein may comprise more than one polysaccharide material dissolved in the alkali material. The polysaccharide material preferably comprises a cellulose material. The solution may include a cellulose material and another polysaccharide material.

Direct dissolution of wood pulp in sodium hydroxide using conventional methods is known to create cellulose solutions that gel in less than 24 hours, often less than 8 hours. However, the inventors have surprisingly found that the solutions of the present invention can be stored for long periods of time, at ambient temperatures, without undergoing irreversible gelation.

The formation of a gel can be measured by eye, or by tracking the elastic modulus G′ and viscous modulus G″, with the point at which the value of G′ meets G″ being the gelation point.

The molecular weight of the one or more polysaccharide materials in the solution may not decrease over a period of at least two weeks when stored at 20° C. The molecular weight of the dissolved one or more polysaccharide materials may not decrease over a period of at least a month when stored at 20° C.

The solution may have a polysaccharide content of 3 to 10% w/w. Preferably the polysaccharide comprises or consists of cellulose. The polysaccharide content may be stable over time. The polysaccharide content may change by less than 20%, preferably less than 10% over a period of two weeks when stored at 20° C.

The solution may comprise less than 3%, preferably less than 1% undissolved polysaccharide. The high-pressure homogenisation treatment can ensure that very low levels of polysaccharide remain undissolved in the solution. This level of undissolved polysaccharide may be achieved without additional separation steps, such as filtering the solution.

The solution may be free from any solubility- or stability-enhancing additives, such as metal oxides, urea, thiourea, polyethylene glycol, acrylamide, acrylic acid and acrylonitrile. These additives are not required to create a stable solution according to the present invention.

The solution may be stored with permanent agitation, which assists in preventing the formation of a gel. The solution may be stored under vacuum. This advantageously avoids moisture ingress and removes gas bubbles prior to product formation.

The solution may be stably thixotropic. In other words, the solution has shear thinning properties that are stable over time, so that no irreversible gelation occurs. For example, the solution according to the present invention may be a reversible gel which reverts back to a liquid under shear. The solution of the present invention may therefore be stored for long periods of time, at ambient temperatures, without undergoing irreversible gelation. This is advantageous over solutions of the prior art, in which irreversible gels are often formed.

The solution may be formed using the method described herein. This solution will be known as the Rahcel solution.

According to a third aspect, there is provided a method of forming a viscose solution, comprising the step of adding the solution described herein to viscose. Preferably, the one or more polysaccharide materials in the solution described herein includes a cellulose material. However, solutions including other polysaccharides can be added in order to change the properties of the viscose solution.

The solution may be added to the viscose such that the one or more polysaccharide materials are present in an amount of up to 50% by weight of the solids content of the viscose. A non-cellulose polysaccharide material in the solution may be added in an amount of up to 25% by weight of the solids content of the viscose.

In embodiments in which the polysaccharide material comprises cellulose, the solution described herein may be added to the viscose such that between 1 and 99%, preferably between 5 and 60% and most preferably between 20 and 50% of the total cellulose content in the viscose solution is derived from the solution described herein.

Thus, this method provides a simple way to create a more environmentally friendly product, as recycled materials can be easily added to the viscose using the solution of the present invention, without significant investment and/or modifications to the plant.

The solution of the invention as described herein can be mixed with any compatible polysaccharide solution. For example, the solution described herein can be mixed with any viscose solutions, cellulose carbamate solutions, other alkali-based solutions or ionic liquid solutions that are compatible with the solution of the invention. The one or more polysaccharide materials in the solution of the invention may include the same polysaccharide as the solution with which it is mixed. The one or more polysaccharide materials in the solution of the invention may be the same as the solution with which it is mixed. The one or more polysaccharide materials in the solution of the invention may contain a different polysaccharide to the solution with which it is mixed.

According to a fourth aspect, there is provided a viscose solution, wherein the viscose solution comprises viscose and the solution described herein. The polysaccharide material in the solution described herein may comprise a cellulose material, or may include a polysaccharide other than cellulose. The inventors have found that the viscose solution of the present invention can be used to form a regenerated cellulose product, which has a lower environmental impact compared to a product formed from only viscose.

According to a fifth aspect, there is provided a method of forming a regenerated cellulose product comprising the steps of contacting a solution comprising a cellulose material dissolved in an alkali as described herein, or a viscose solution as described herein, with an acidic solution. The regenerated cellulose product may be formed using conventional regeneration methods.

The regenerated cellulose product may be a film, a fibre or a shaped article, such as a bead or foam. The acidic solution may be an acid bath, which may comprise hydrochloric acid.

According to a sixth aspect, there is provided a regenerated cellulose product created using the method of forming a regenerated cellulose product described herein. Thus, the regenerated cellulose product may be a film, a fibre or a shaped article, such as a bead or foam.

The product may be a film or a fibre having a normalised peak energy of more than 20%, preferably more than 30% greater than the normalised peak energy of a corresponding film or fibre that was not made using the solution described herein. By “corresponding film or fibre”, it is meant a film or fibre with the same properties such as thickness, that has been manufactured in the same manner.

Normalised peak energy can be measured on a falling dart impact tester using the method according to ASTM D638. An increase in normalised peak energy means a reduction in brittleness, which is of significant value in both film and fibre production.

The product may be a film or a fibre having a displacement at failure of more than 10%, preferably more than 15% greater than the displacement at failure of a corresponding film or fibre that was not made using the solution described herein. The displacement at failure may be measured using a dart with a head diameter of 12.7 mm and an impact speed of 2 m/s.

According to a seventh aspect, there is provided a regenerated cellulose film having an elongation at break in the transverse direction of greater than 30%, preferably greater than 45%, more preferably greater than 50%. The film of the present invention therefore demonstrates improved mechanical properties than conventional films in the art, demonstrating a lower brittleness.

The regenerated cellulose film according to this aspect may be formed from the solution of a cellulose material dissolved in an alkali or the viscose solution discussed above. The regenerated cellulose film may have a normalised peak energy of more than 30% greater than the normalised peak energy of a corresponding film that was not made using the solution described herein, and/or a displacement at failure of more than 10% greater than the displacement at failure of a corresponding film that was not made using the solution described herein.

Any feature relating to any aspect of the present invention may equally apply to any other aspect discussed herein.

The invention will now be more particularly described with reference to the following non-limiting examples and figures, in which;

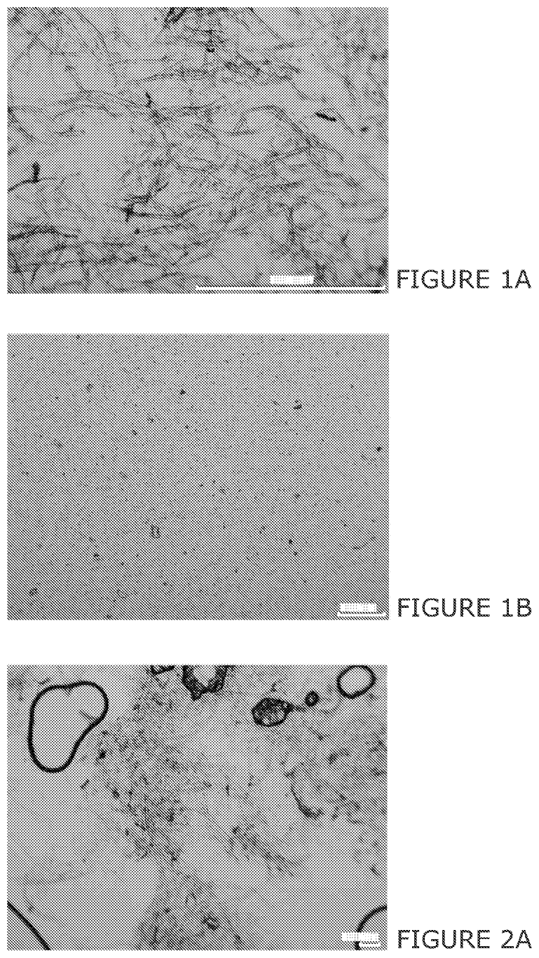

FIG. 1 illustrates a solution containing NaOH and cellulose from tomato leaves, both before (1A) and after (1B) high-pressure homogenisation;

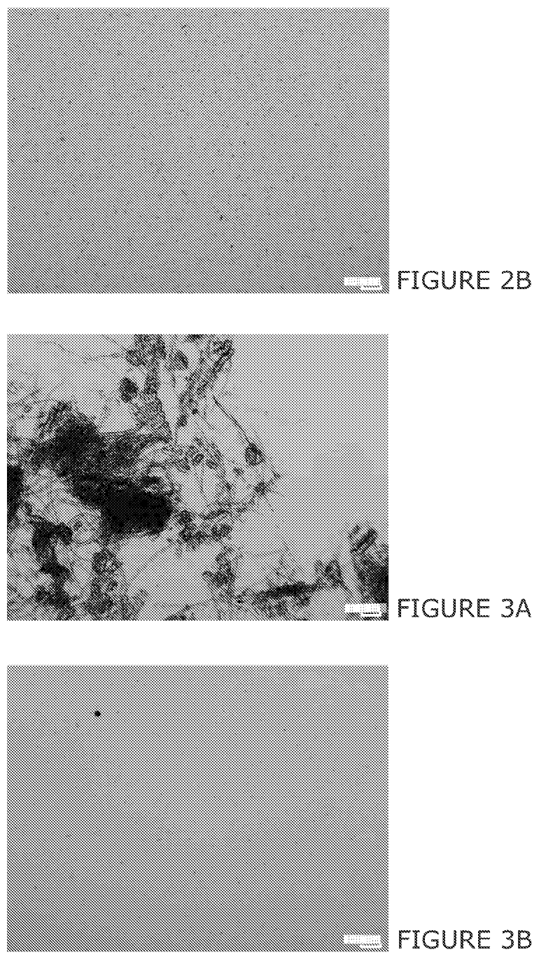

FIG. 2 illustrates a solution containing NaOH and cellulose from straw, both before (2A) and after (2B) high-pressure homogenisation;

FIG. 3 illustrates a solution containing NaOH and cellulose from rice husks, both before (3A) and after (3B) high-pressure homogenisation;

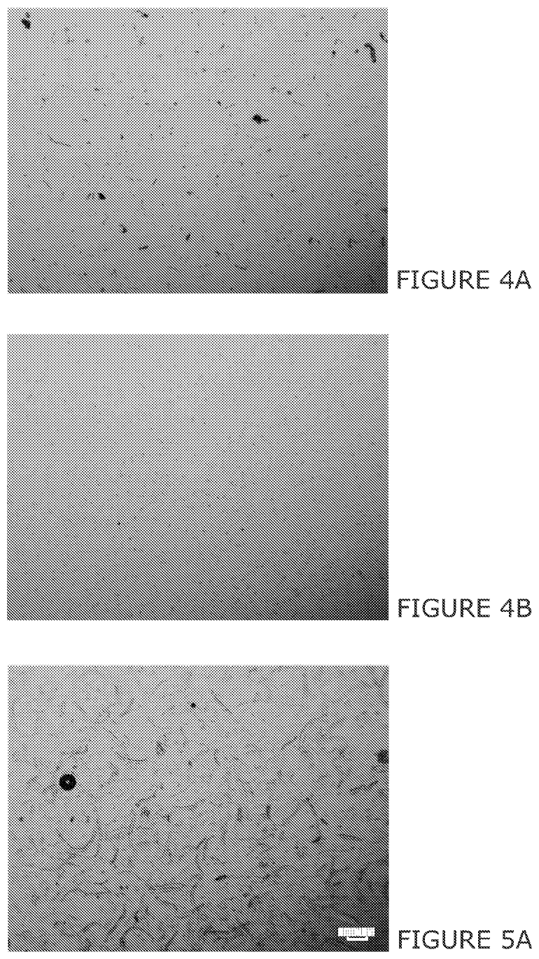

FIG. 4 illustrates a solution containing NaOH and cellulose from straw, both before (4A) and after (4B) high-pressure homogenisation;

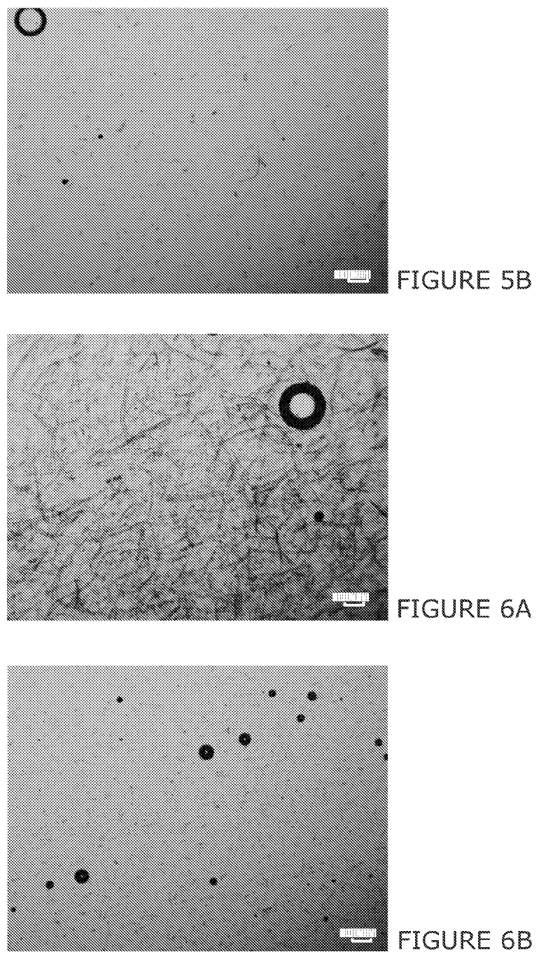

FIG. 5 illustrates a solution containing NaOH and cellulose from straw, both before (5A) and after (5B) high-pressure homogenisation;

FIG. 6 illustrates a solution containing NaOH and cellulose from hemp, both before (6A) and after (6B) high-pressure homogenisation;

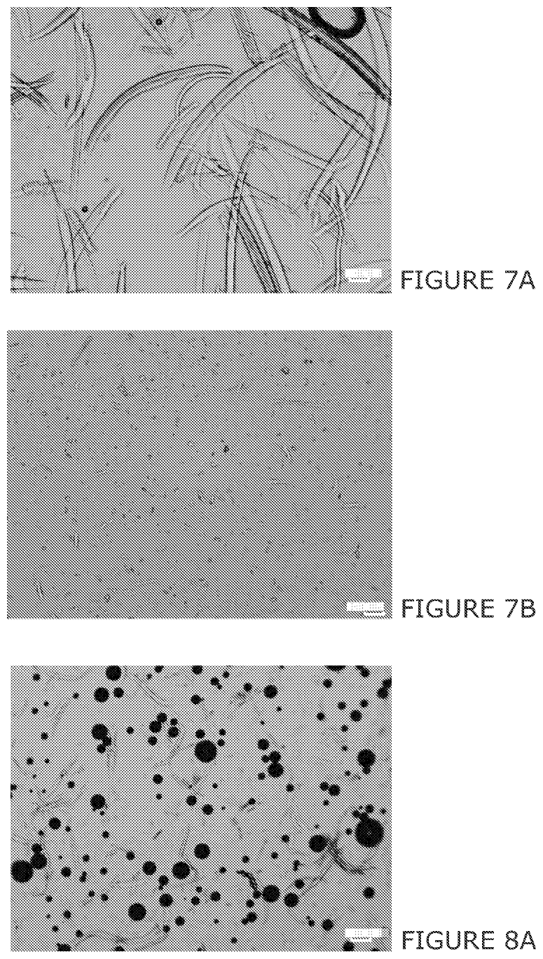

FIG. 7 illustrates a solution containing NaOH and cellulose from oat hulls, both before (7A) and after (7B) high-pressure homogenisation;

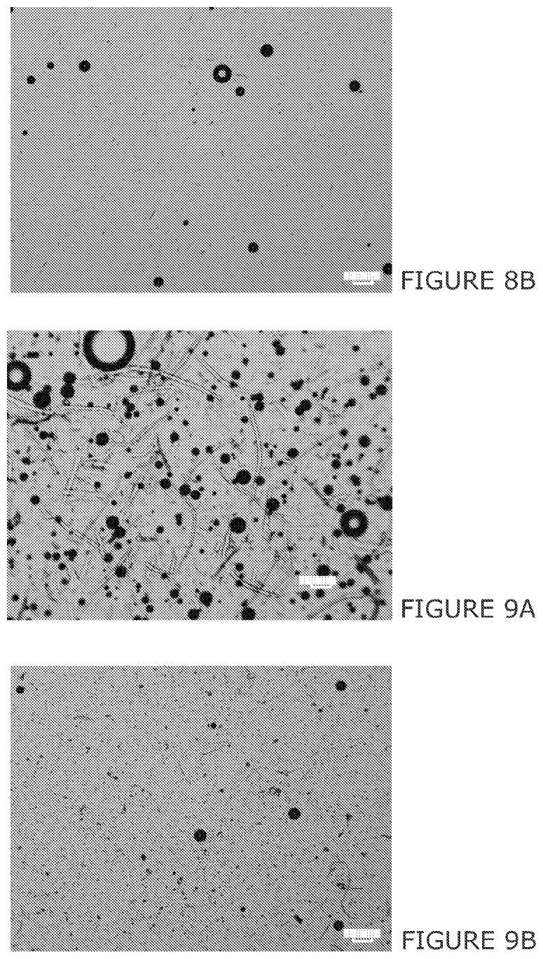

FIG. 8 illustrates a solution containing NaOH and cellulose from hemp, both before (8A) and after (8B) high-pressure homogenisation;

FIG. 9 illustrates a solution containing NaOH and cellulose from tomato leaves, both before (9A) and after (9B) high-pressure homogenisation;

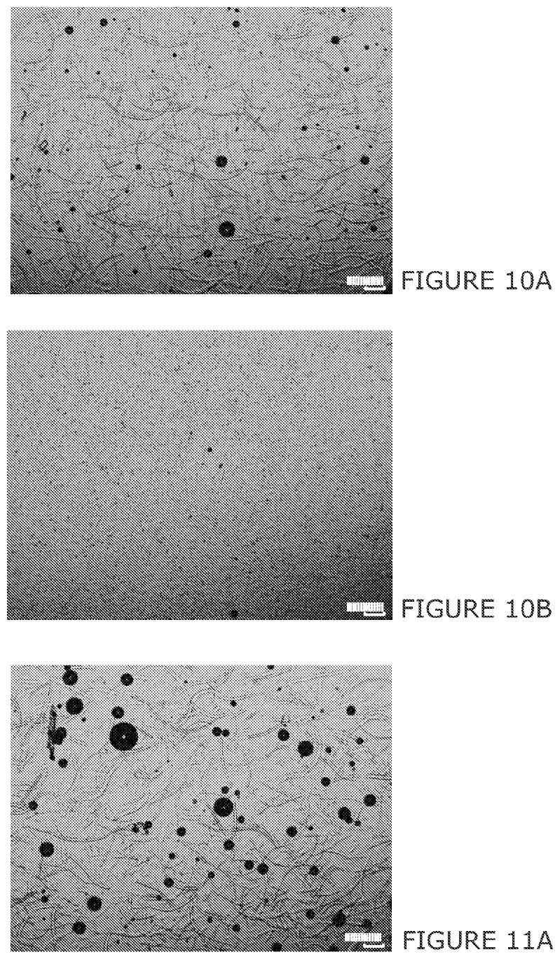

FIG. 10 illustrates a solution containing NaOH and cellulose from hemp, which has undergone a pre-treatment, both before (10A) and after (10B) high-pressure homogenisation;

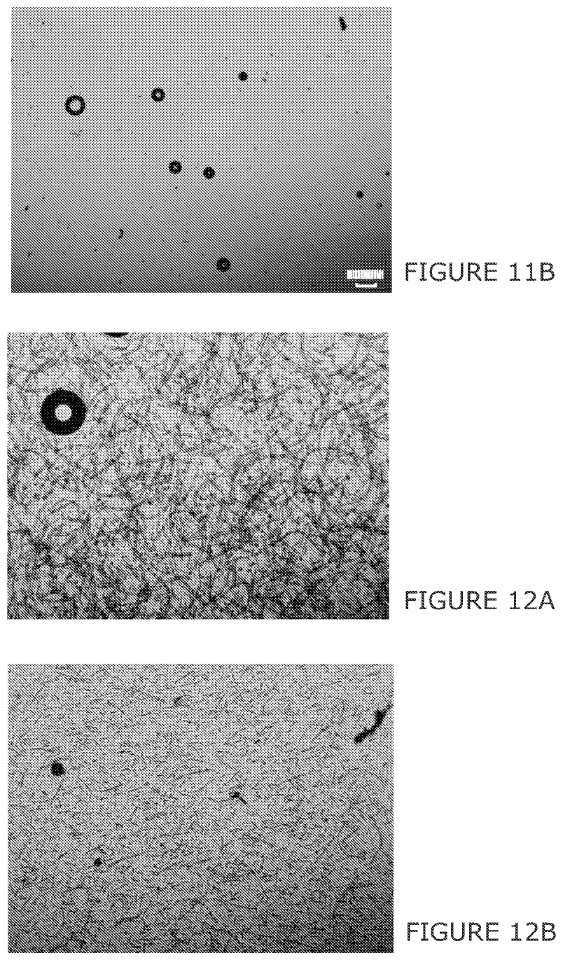

FIG. 11 illustrates a solution containing NaOH and cellulose from hemp, which has undergone a pre-treatment, both before (11A) and after (11B) high-pressure homogenisation;

FIG. 12 illustrates a solution containing NaOH and plant alkali cellulose, which has undergone a pre-treatment, both before (12A) and after (12B) high-pressure homogenisation;

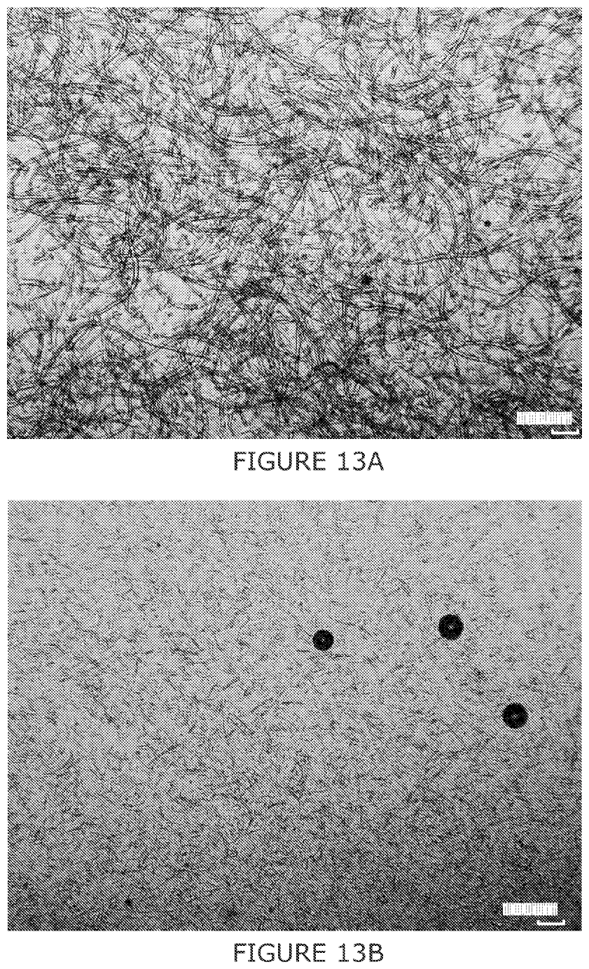

FIG. 13 illustrates a solution containing NaOH and plant alkali cellulose, which has undergone a pre-treatment, both before (13A) and after (13B) high-pressure homogenisation;

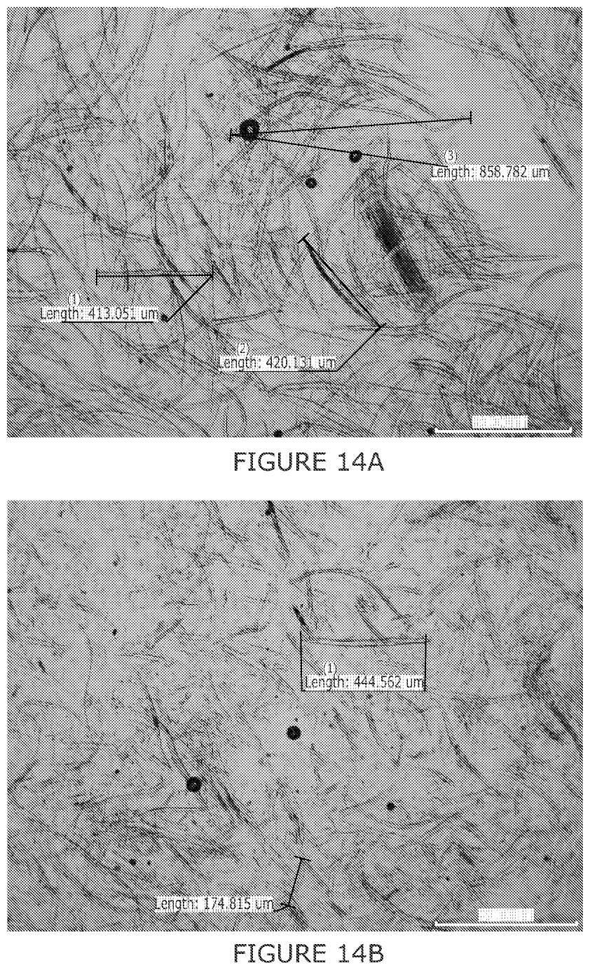

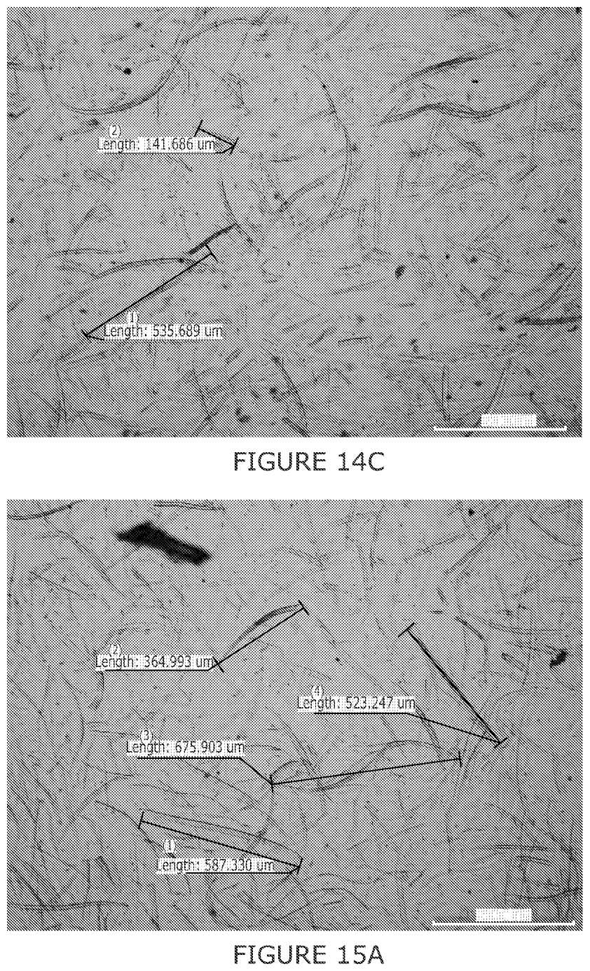

FIG. 14 illustrates a solution containing NaOH and cellulose prior to homogenisation (14A), after one pass through the high-pressure homogeniser (14B), and after two passes through the high-pressure homogeniser (14C), wherein the solution was held for 30 minutes prior to high-pressure homogenisation;

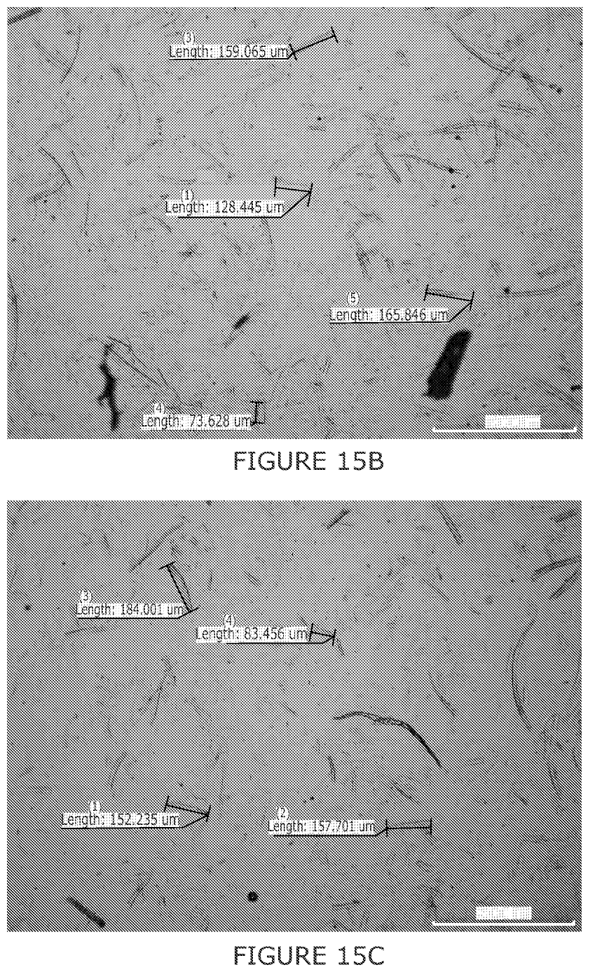

FIG. 15 illustrates a solution containing NaOH and cellulose prior to homogenisation (15A), after one pass through the high-pressure homogeniser (15B), and after two passes through the high-pressure homogeniser (15C), wherein the solution was held for 2 hours prior to high-pressure homogenisation;

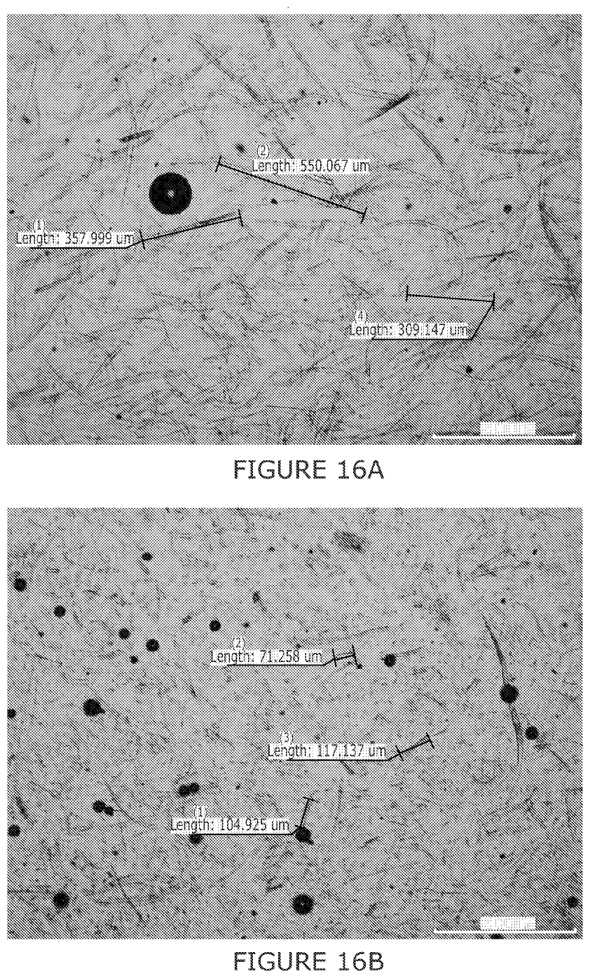

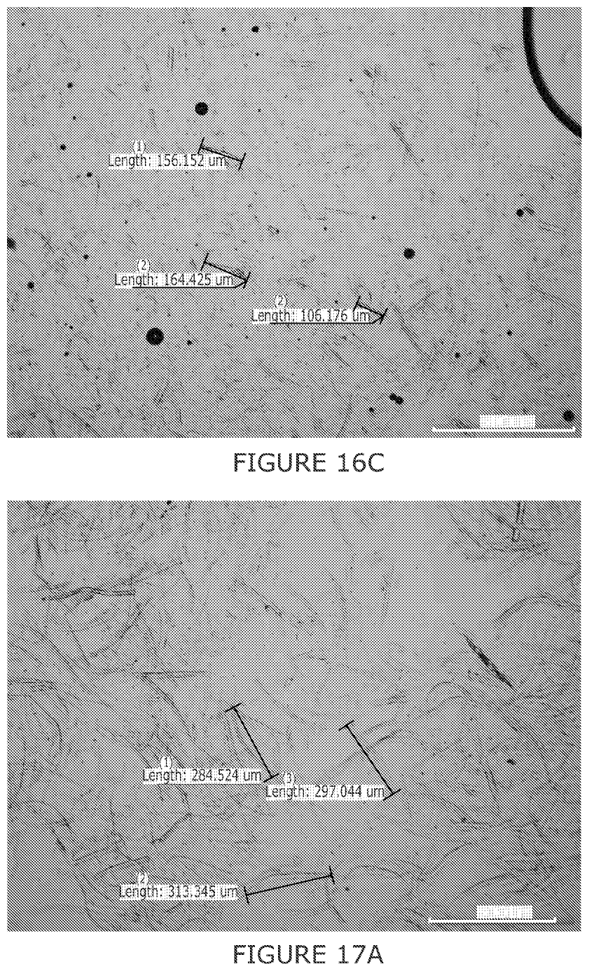

FIG. 16 illustrates a solution containing NaOH and cellulose prior to homogenisation (16A), after one pass through the high-pressure homogeniser (16B), and after two passes through the high-pressure homogeniser (16C), wherein the solution was held for 12 hours prior to high-pressure homogenisation;

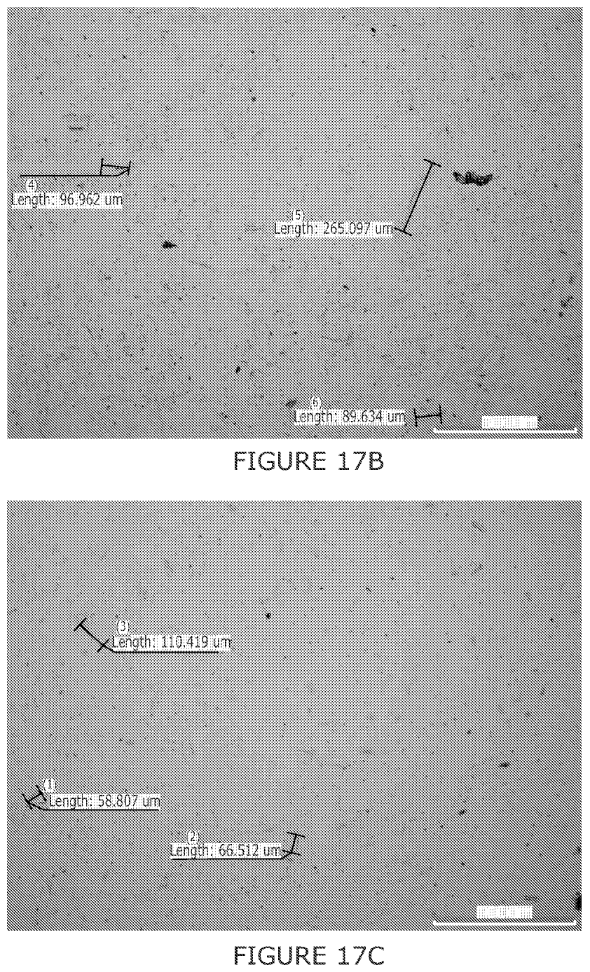

FIG. 17 illustrates a solution containing NaOH and cellulose prior to homogenisation (17A), after one pass through the high-pressure homogeniser (17B), and after two passes through the high-pressure homogeniser (17C), wherein the solution was held for 72 hours prior to high-pressure homogenisation;

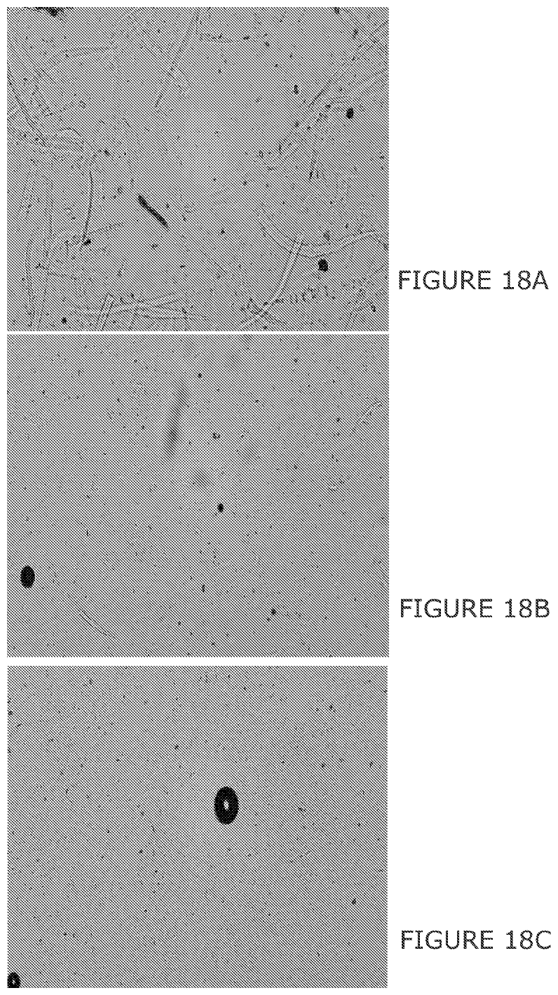

FIG. 18 illustrates a solution containing NaOH at −20° C. and cellulose prior to homogenisation (18A), after one pass through the high-pressure homogeniser (18B), and after two passes through the high-pressure homogeniser (18C), wherein the solution was mixed at 2° C. for 20 minutes prior to high-pressure homogenisation;

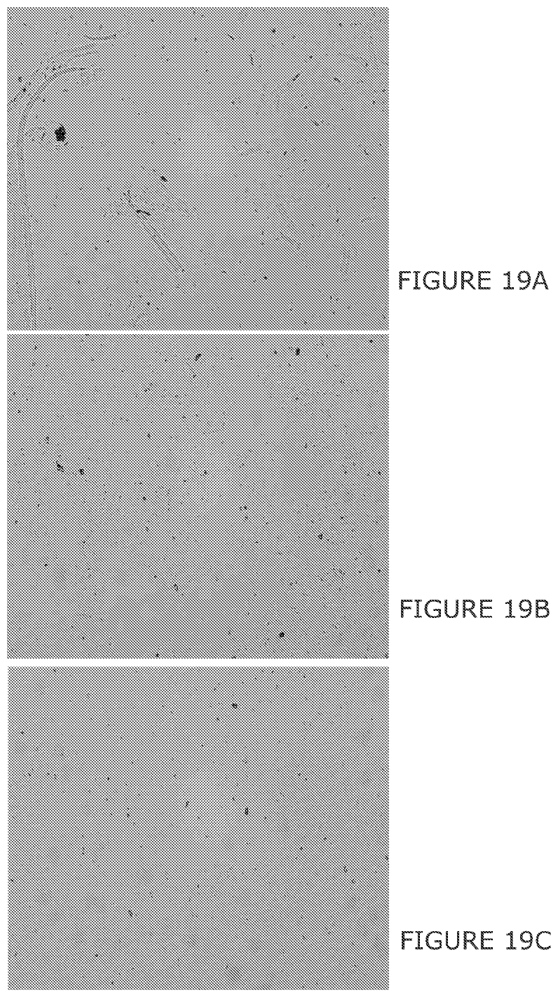

FIG. 19 illustrates a solution containing NaOH at −20° C. and cellulose prior to homogenisation (19A), after one pass through the high-pressure homogeniser (19B), and after two passes through the high-pressure homogeniser (19C), wherein the solution was mixed at 2° C. for 24 hours prior to high-pressure homogenisation;

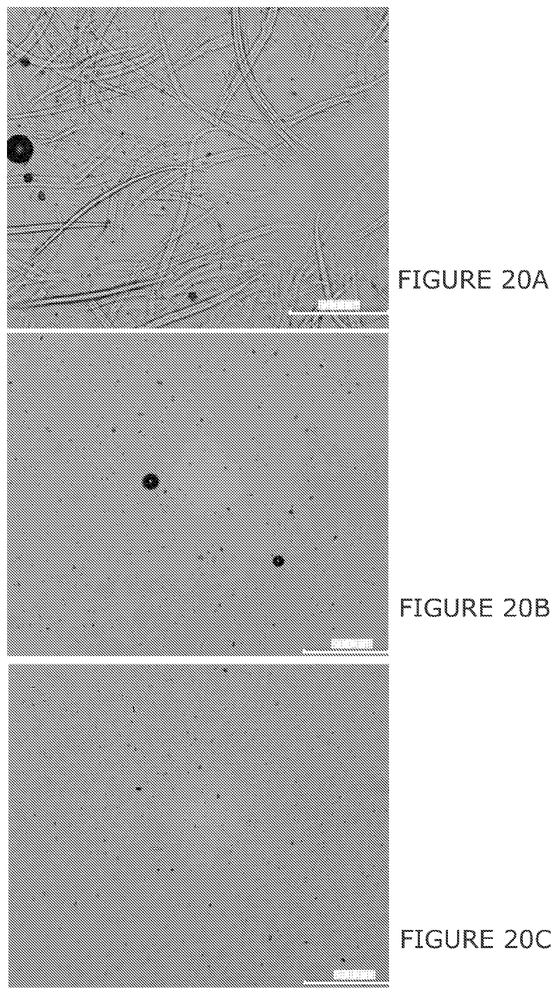

FIG. 20 illustrates a solution containing ambient temperature NaOH and cellulose prior to homogenisation (20A), after one pass through the high-pressure homogeniser (20B), and after two passes through the high-pressure homogeniser (20C), wherein the solution was mixed at 2° C. for 20 minutes prior to high-pressure homogenisation;

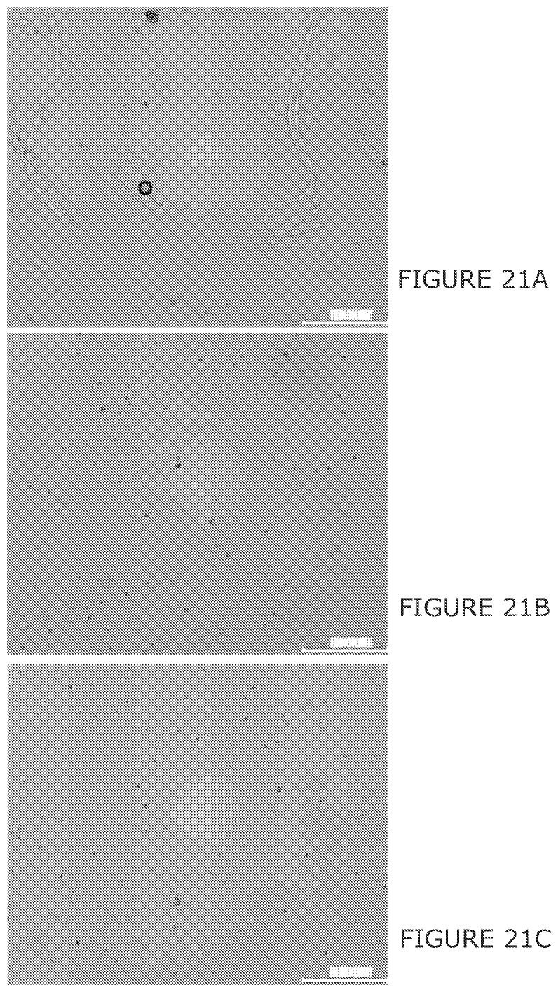

FIG. 21 illustrates a solution containing ambient temperature NaOH and cellulose prior to homogenisation (21A), after one pass through the high-pressure homogeniser (21B), and after two passes through the high-pressure homogeniser (21C), wherein the solution was mixed at 2° C. for 24 hours prior to high-pressure homogenisation;

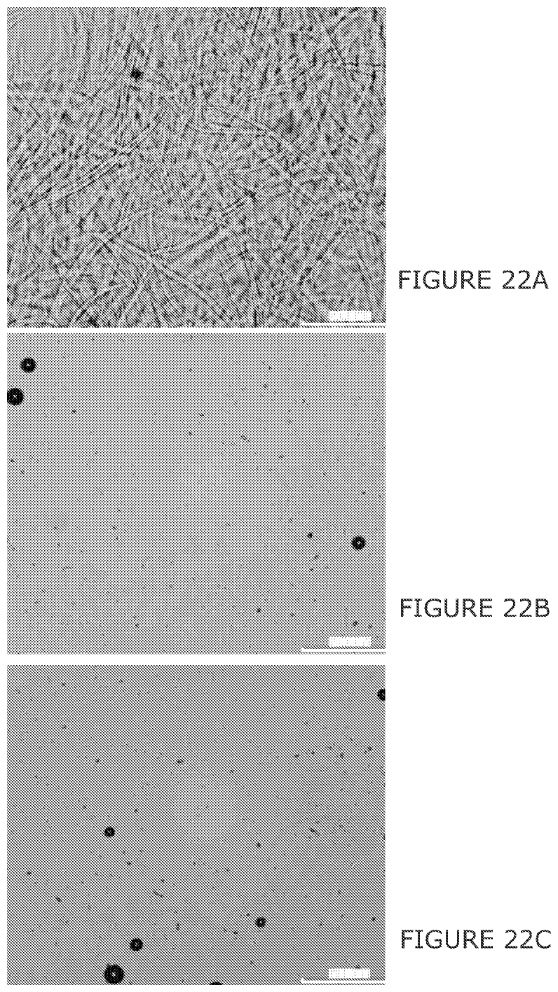

FIG. 22 illustrates a solution containing ambient temperature NaOH and cellulose prior to homogenisation (22A), after one pass through the high-pressure homogeniser (22B), and after two passes through the high-pressure homogeniser (22C), wherein the solution was mixed at ambient temperature for 20 minutes prior to high-pressure homogenisation; and

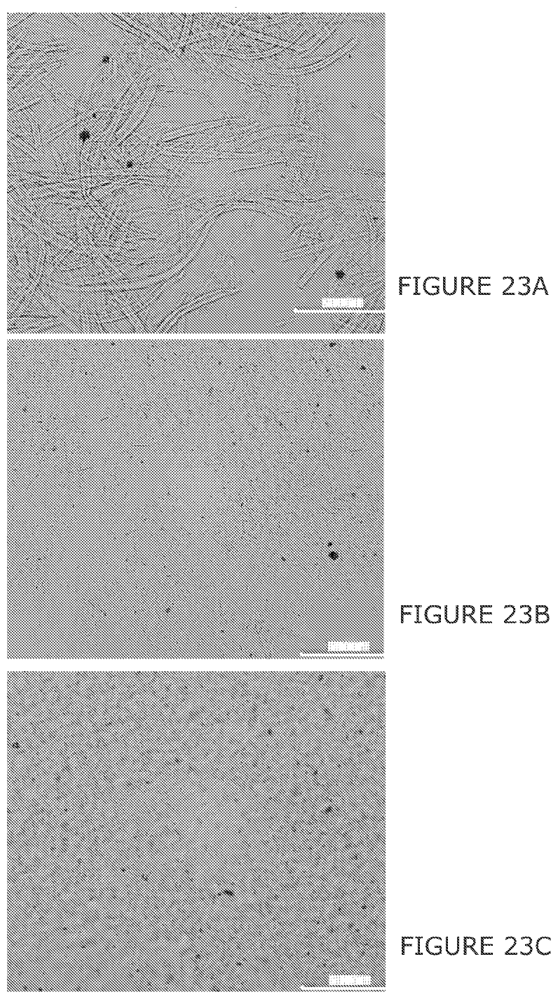

FIG. 23 illustrates a solution containing ambient temperature NaOH and cellulose prior to homogenisation (23A), after one pass through the high-pressure homogeniser (23B), and after two passes through the high-pressure homogeniser (23C), wherein the solution was mixed at ambient temperature for 24 hours prior to high-pressure homogenisation.

### Cellulose Dissolution

Several solutions were made, with each solution containing sodium hydroxide and cellulose from one of a variety of sources as the polysaccharide material, as outlined in Table 1. The polysaccharide material in Examples 10 to 13 was first subjected to a pre-treatment, as also outlined in Table 1. In all examples, the sodium hydroxide was cooled to a temperature of −18° C. before being added to the polysaccharide material.

For each example, two samples were made: Sample A, which was not subjected to high-pressure homogenisation and remained as a premix; and Sample B, which was subjected to high-pressure homogenisation. The “Temperature of Homogenisation” quoted is the temperature of the solution at the start of the high-pressure homogenisation step.

TABLE 1

| | | | High-Pressure | Temperature of | |
|---|---|---|---|---|---|
| Example | Solution | Sample | Homogenisation? | Homogenisation | FIG. |
| 1 | 3% cellulose from tomato | A | None, premix | N/A | 1A |
| | leaves | B | 700 bar for the first | 3° C. | 1B |
| | 6% NaOH | | pass and then 100 bar | | |
| | | | for 6 passes | | |
| 2 | 4.5% cellulose from | A | None, premix | N/A | 2A |
| | straw | B | 700 bar for 6 passes | 25° C. for the first 5 | 2B |
| | 6% NaOH | | | passes (followed by | |
| | | | | 30 mins recirculation | |
| | | | | @ 100 bar) then 5° C. | |
| | | | | for the last pass | |
| 3 | 3% cellulose from rice | A | None, premix | N/A | 3A |
| | husks | B | 700 bar for 4 passes | 3° C. | 3B |
| | 6% NaOH | | | | |
| 4 | 5% cellulose from straw | A | None, premix | N/A | 4A |
| | 7.8% NaOH | B | 700 bar for 1 pass | 4° C. | 4B |
| 5 | 7.5% cellulose from | A | None, premix | N/A | 5A |
| | straw | B | 700 bar for 2 passes | 2° C. (followed by 30 | 5B |
| | 6% NaOH | | | mins recirculation at | |
| | | | | 2° C.) | |
| 6 | 6.3% cellulose from | A | None, premix | N/A | 6A |
| | hemp | B | 700 bar for the first | 2° C. (followed by 30 | 6B |
| | 5.7% NaOH | | pass and then 150 bar | mins recirculation at | |
| | | | for 1 pass | 2° C.) | |
| 7 | 5% cellulose from oat | A | None, premix | N/A | 7A |
| | hulls | B | 750 bar for 2 passes | 2° C. | 7B |
| | 7.8% NaOH | | | | |
| 8 | 5% cellulose from hemp | A | None, premix | N/A | 8A |
| | 7.8% NaOH | B | 700 bar for the first | 2° C. (followed by 30 | 8B |
| | | | pass and then 100 bar | mins recirculation at | |
| | | | for 3 passes | 2° C.) | |
| 9 | 5% cellulose from tomato | A | None, premix | N/A | 9A |
| | leaves | B | 700 bar for the first | 2° C. (followed by 30 | 9B |
| | 7.8% NaOH | | pass and then 100 bar | mins recirculation at | |
| | | | for 3 passes | 2° C.) | |
| 10 | 5% cellulose from hemp | A | None, premix | N/A | 10A |
| | 7.8% NaOH | | | | |
| | The hemp was pre- | | | | |
| | treated using a 2-stage | | | | |
| | sodium hydroxide | | | | |
| | treatment: 0.4% NaOH | B | 750 bar for the first | 2° C. | 10B |
| | for 7 hrs then 2% NaOH | | pass and then 150 bar | | |
| | for a further 14 hrs, | | for 3 passes | | |
| | followed by | | | | |
| | neutralisation and | | | | |
| | bleaching. | | | | |
| 11 | 5% cellulose from hemp | A | None, premix | N/A | 11A |
| | 7.8% NaOH | | | | |
| | The hemp was pre- | | | | |
| | treated using a single 4% | | | | |
| | NaOH treatment at 50° C., | B | 750 bar for the first | 2° C. | 11B |
| | followed by | | pass and then 150 bar | | |
| | neutralisation and | | for 3 passes | | |
| | bleaching. | | | | |
| 12 | 5% cellulose from pre- | A | None, premix | N/A | 12A |
| | hydrolysis kraft | | | | |
| | dissolving wood pulp | | | | |
| | from Eucalyptus | | | | |
| | 7.8% NaOH | B | 750 bar for the first | 2° C. | 12B |
| | The cellulose was alkali | | pass and then 150 bar | | |
| | pre-treated, neutralised, | | for 2 passes | | |
| | washed, bleached and | | | | |
| | washed in the laboratory. | | | | |
| 13 | 5% cellulose from pre- | A | None, premix | N/A | 13A |
| | hydrolysis kraft | | | | |
| | dissolving wood pulp | | | | |
| | from Eucalyptus | | | | |
| | 7.8% NaOH | | | | |
| | The cellulose was alkali | B | 750 bar for the first | 2° C. | 13B |
| | pre-treated with a low | | pass and then 150 bar | | |
| | NaOH concentration | | for 5 passes | | |
| | solution, neutralised and | | | | |
| | washed in the laboratory. | | | | |

It was observed that the solution viscosity immediately as the solution exited the high-pressure homogenizer was extremely high, almost paste-like. This is a sign that the cellulose fibre length was initially reduced, creating a high fibre surface area and a high demand on the liquid, thereby increasing viscosity. A sudden drop in viscosity was then seen quickly after, as the cellulose fragments dissolved and so the fibre surface area reduced. At this point, the viscosity is a function of the molecular weight of the cellulose and not of the fibre surface area. The recirculation step helped to reduce the viscosity, thereby indicating that it helped dissolution of the cellulose fragments.

Images of the resulting solutions were taken using a microscope and a camera and are shown in FIGS. 1 to 13.

FIGS. 1 to 13 demonstrate that Sample B in all examples exhibited improved cellulose dissolution as compared to Sample A, as illustrated by the reduced degree of cellulose particulates seen in the images. Thus, high-pressure homogenisation increases the solubility of the cellulose material in alkali, even when conducted at higher temperatures than conventionally known in the art.

While the main polysaccharide dissolved in the alkali in these examples is cellulose, other polysaccharides present in plant material would also be dissolved in the alkali, such as xylan, xyloglucan, callose, beta glucans and glucomannan.

### Yield and Solids Content of Homogenised Solution

The yield and solids content of some of the final homogenised samples were analysed. The yield test was done through a four-phase filtration method, in which a sample of a known weight was passed through glass funnel filters with different mesh size pores. The grade of each filter was as follows:
Phase 1: 100->160 μm
Phase 2: 40-100 μm
Phase 3: 16-40 μm
Phase 4: 10-16 μm

The sample was pulled through each filter using a Buchner funnel and vacuum pump. The passed solution weight was weighed and used to calculate the undissolved portion of the sample, which provided the overall yield of the final solution.

The solids content was tested using a method in which a sample of a known weight was neutralised and regenerated with 10% acetic acid, and subsequently passed through a pre-weighed graded cinter while continuously being washed with warm water. Once the sample was free of any remaining caustic soda or acetic acid, the cinter was dried overnight in a vacuum oven at approximately 120° C. The cinter was weighed again and the three weights were used to calculate the overall solids content of the samples.

The overall yield and solids content for samples 4B, 5B and 7B can be found in Table 2. As can be seen, all three samples achieved a very high yield.

TABLE 2

| Sample | Yield % | Solids % |
|---|---|---|
| 4B | 99.87 | 3.54 |
| 5B | 99.70 | 6.87 |
| 7B | 98.75 | 3.62 |

### Effect of a Saturation Step Prior to Homogenisation on Cellulose Dissolution

Four cellulose solutions were made (Examples 14-17), all of which contained 5% cellulose and 7.8% NaOH. The solution was formed by mixing aqueous NaOH at −18° C. and a concentration of 18% with ambient temperature water and wood pulp. Subsequently, the solution temperature was raised to 8° C.

Each solution was then held in a saturation step at 8° C. for a different period of time prior to homogenisation. Example 14 (FIG. 14) was held for 30 minutes; Example 15 (FIG. 15) was held for 2 hours; Example 16 (FIG. 16) was held for 12 hours; and Example 17 (FIG. 17) was held for 72 hours. The figures show the solutions prior to homogenisation but after the saturation step (A), after one pass through the high-pressure homogeniser (B), and after two passes through the high-pressure homogeniser (C).

The first high-pressure homogenisation step occurred at 600 bar and the second occurred at 100 bar. The temperature of the mixture at the start of homogenisation was 8° C., which increased to between 25 and 30° C. during high-pressure homogenisation. The mixture was cooled to 8° C. between the first and second high-pressure homogenisation step.

FIGS. 14 to 17 demonstrate that holding the solutions at a temperature below ambient temperature for a longer period of time prior to homogenisation improves cellulose dissolution, as illustrated by the reduced degree of cellulose particulates seen in FIGS. 14C, 15C, 16C and 17C. The longer the saturation step, the better the degree of cellulose dissolution.

Comparing FIGS. 14A, 15A, 16A and 17A, it would appear that the cellulose particles start to dissolve during the saturation step. Without wishing to be bound by theory, it is thought that this initial dissolution during the saturation step aids the dissolution during high-pressure homogenisation, despite the increased temperatures involved.

A further experiment was then conducted investigating the effect of the saturation step on the temperatures required during the dissolution process.

Hemp pulp was dissolved in 18% sodium hydroxide at different temperatures, before undergoing a saturation step of either 20 minutes or 24 hours (FIGS. 18A, 19A, 20A, 21A, 22A and 23A). The solution was then treated with a first high-pressure homogenisation step at 750 bar (FIGS. 18B, 19B, 20B, 21B, 22B and 23B), followed by a second high-pressure homogenisation step at 150 bar (FIGS. 18C, 19C, 20C, 21C, 22C and 23C).

FIGS. 18 and 19 illustrate the results seen when the sodium hydroxide was cooled to −20° C., before undergoing a saturation step at 2° C. for 20 minutes and 24 hours respectively. FIGS. 20 and 21 illustrate the results seen when the sodium hydroxide was added at ambient temperature, before undergoing a saturation step at 2° C. for 20 minutes and 24 hours respectively. FIGS. 22 and 23 illustrate the results seen when the sodium hydroxide was added at ambient temperature, before undergoing a saturation step at ambient temperature for 20 minutes and 24 hours respectively. The temperature of the solution at the start of the high-pressure homogenisation step was the same as that during the saturation step.

As demonstrated by these figures, a longer saturation step helps to increase the amount of dissolution and increased dissolution is seen at lower temperatures. These figures also demonstrate that the inclusion of a saturation step before high-pressure homogenisation allows the dissolution process to occur at higher temperatures than conventionally used in the art. In fact, good dissolution results are seen even when both the sodium hydroxide and the high-pressure homogenisation steps are at ambient temperature.

### Mechanical Properties

A regenerated cellulose film was created by extruding a solution of a cellulose material dissolved in an alkali according to the present invention, in which the solution contained 10% tomato leaf and the alkali was sodium hydroxide, into an acid bath.

The mechanical properties of the regenerated cellulose film (Tomato) were compared to a control cellulose film (Control) of the same thickness and formed in the same manner but made from conventional viscose. The results can be found in Table 3.

As can be seen, the regenerated cellulose film according to the present invention had comparable properties in the machine direction (MD) and improved properties in the transverse direction (TD), particularly with respect to elongation break % in the transverse direction. Advantageously, the improvement in the elongation of the film in the transverse direction was achieved without detriment to the other properties.

Tests were conducted in a conditioned environment where the temperature was 23° C. and the relative humidity was 50%. The machine used is the Instron 3342—Series IX Automated Materials Tester—with Static Load Cell+5 kN−No. 115—pneumatic tensile grips.

TABLE 3

| | | Elongation | Max Tensile | Youngs | 1% Secant |
|---|---|---|---|---|---|
| | | @ Break % | Strength | Modulus | Modulus |
| Sample | Direction | (mm) | (MPa) | (MPa) | (MPa) |
| Control | MD | 20.9 | 76.5 | 2966 | 2627 |
| Tomato | MD | 18.2 | 87.9 | 3889 | 2920 |
| Control | TD | 24.2 | 44.8 | 1641 | 1546 |
| Tomato | TD | 54.1 | 44.3 | 1962 | 1624 |

The same films were tested on a falling dart impact tester using the method according to ASTM D638 to ascertain the normalised peak energy. The displacement at failure was measured using a dart with a head diameter of 12.7 mm and an impact speed of 2 m/s. The results can be found in Table 4. As can be seen, the peak energy of the control film increased upon the addition of tomato leaf. Thus, the inclusion of a solution according to the present invention in a film improves the resistance of said film.

TABLE 4

| | Normalised Peak Energy | Displacement |
|---|---|---|
| Sample | (J/mm) | at Failure |
| Control | 5.2 ± 0.3 | 5.8 |
| Tomato | 7.1 | 6.7 |

The film according to the present invention demonstrates a higher normalised peak energy, thereby demonstrating a reduced brittleness compared to the control film. The film according to the present invention also demonstrated a greater displacement at failure. Thus, the film of the present invention can absorb more energy before it fails and so is more resistant to breakage.

1. A method for creating a solution comprising one or more polysaccharide materials dissolved in an alkali, comprising the step of subjecting a mixture comprising the one or more polysaccharide materials and the alkali to high-pressure homogenisation.

2. The method of claim 1, wherein the temperature of the solution during at least part of the high-pressure homogenisation is greater than 0° C. and/or wherein the temperature of the solution during the high-pressure homogenisation does not exceed 35° C.

3. The method of claim 1, wherein the one or more polysaccharide materials are initially mixed with water at a temperature of between −5° C. and 10° C. and optionally further wherein the alkali is cooled to a temperature of between −25° C. and −10° C. and is then added to the mixture comprising the one or more polysaccharide materials and water to create the mixture comprising the one or more polysaccharide materials and the alkali.

4. The method of any preceding claim 1, wherein the mixture comprising the one or more polysaccharide materials and the alkali is treated to increase the homogeneity of the mixture before the high-pressure homogenisation, optionally by using a high shear mixer.

5. The method of claim 1, wherein the mixture comprising the one or more polysaccharide materials and the alkali undergoes a plurality of high-pressure homogenisation steps, optionally wherein the mixture is cooled to between −5° C. and 15° C., between at least two of the high-pressure homogenisation steps.

6. The method of claim 1, wherein the mixture comprising the one or more polysaccharide materials and the alkali is cooled to between −5° C. and 15° C., directly after all of the one or more high-pressure homogenisation steps.

7. The method of claim 5, wherein the mixture comprising the one or more polysaccharide materials and the alkali is held at a temperature of between −5° C. and 15° C. before high-pressure homogenisation, between two or more high-pressure homogenisation steps and/or after all of the one or more high-pressure homogenisation steps.

8. The method of claim 1, wherein some or all of the one or more polysaccharide materials are pre-treated with a pre-treatment alkali solution.

9. The method of claim 8, wherein the pre-treatment comprises mixing the one or more polysaccharide materials with a pre-treatment alkali solution, separating the one or more polysaccharide materials from said pre-treatment alkali solution, neutralising the one or more polysaccharide materials with an acid and optionally treating the one or more polysaccharide materials with a bleach.

10. The method of claim 1, wherein the alkali and/or the pre-treatment alkali solution is aqueous sodium hydroxide.

11. The method of claim 1, wherein the mixture comprising the one or more polysaccharide materials and the alkali comprises between 1 and 10% w/w polysaccharide material, and between 1 and 15% w/w alkali.

12. The method of claim 1, wherein the one or more polysaccharide materials comprise a cellulose material, optionally wherein the degree of polymerisation in the cellulose material before high-pressure homogenisation is less than 500.

13. The method of claim 1, wherein the high-pressure homogenisation occurs at a pressure of between 100 and 1000 bar.

14. The method of claim 5, wherein a second high-pressure homogenisation step uses a pressure between 15 and 30% of the pressure in a first high-pressure homogenisation step, optionally wherein the total combined pressure of the high-pressure homogenisation steps does not exceed 1000 bar.

15. The method of claim 1, wherein more than 95% of the one or mom polysaccharide materials in the mixture dissolves in the alkali following high-pressure homogenisation.

16. A solution comprising one or more polysaccharide materials dissolved in an alkali, wherein the solution does not undergo irreversible gelation at 20° C. for at least two weeks.

17. The solution of claim 16, wherein the polysaccharide content is 3 to 10% w/w and/or wherein there is less than 3% polysaccharide undissolved in the solution.

18. (canceled)

19. A method of forming a viscose solution, comprising the step of adding the solution of claim 16 to viscose.

20. A viscose solution, wherein the viscose solution comprises viscose and the solution of claim 16.

21. A method of forming a regenerated cellulose product comprising the step of contacting a solution according to claim 16, wherein the polysaccharide material is a cellulose material, or a viscose solution comprising viscose and the solution of claim 16, with an acidic solution.

22. The method according to claim 21, wherein the regenerated cellulose product is a film, a fibre or a shaped article.

23. A regenerated cellulose product created using the method of claim 21.

24. The regenerated cellulose product of claim 23, wherein the product is a film having a normalised peak energy of more than 30% greater than the normalised peak energy of a corresponding film that was not made using a solution comprising one or more polysaccharide materials dissolved in an alkali, wherein the solution does not undergo irreversible Relation at 20° C. for at least two weeks and/or a displacement at failure of more than 10% greater than the displacement at failure of a corresponding film that was not made using the solution.

25. A regenerated cellulose film having an elongation at break in the transverse direction of greater than 30%.
